(19) United States
(12) Patent Application Publication
(10) Pub. No.: US 2022/0156829 A1
(43) Pub. Date: May 19, 2022

(54) Secure Messaging Systems and Methods

(71) Applicant: CapConnect+ Inc., San Carlos, CA (US)

(72) Inventors: Richard Lautch, Yarrow Point, WA (US); Armen Solakhyan, Mill Valley, CA (US)

(21) Appl. No.: 17/527,877

(22) Filed: Nov. 16, 2021

Related U.S. Application Data
(60) Provisional application No. 63/115,001, filed on Nov. 17, 2020.
(60) Provisional application No. 63/118,558, filed on Nov. 25, 2020.

(51) Int. Cl. G06Q 30/08; G06Q 30/06; G06F 11/34

(52) U.S. Cl. CPC G06Q 30/08; G06F 11/3495; G06Q 30/0643

(57) ABSTRACT

Exemplary embodiments include a secure messaging system configured with at least one processor to execute instructions stored in memory, the system comprising a data retention system and a data science system, a web services layer providing access to the data retention and data science systems, a batching service, wherein an application server layer transmits a request to the web services layer for data, the request processed by the batching service transparently to a user, the request processed by the batching service transparently to the user such that the user can continue to use a user-facing application without disruption, an application server layer that provides the user-facing application that accesses the data retention and data science systems through the web services layer, and performs processing based on user interaction with a messaging application, the messaging application configured to execute instructions including generating a dynamically displayed specific, structured interactive graphical user interface paired with a prescribed functionality directly related to the interactive graphical user interface's structure.

### CROSS REFERENCE TO RELATED APPLICATIONS

The present U.S. Non-Provisional patent application claims the priority benefit of U.S. Provisional Patent Application Ser. No. 63/115,001 filed on Nov. 17, 2020 and titled, “Secure Messaging Systems and Methods,” and the present U.S. Non-Provisional patent application claims the priority benefit of U.S. Provisional Patent Application Ser. No. 63/118,558 filed on Nov. 25, 2020 and titled “Secure Messaging Systems and Methods,” both of which are hereby incorporated by reference in their entireties.

### FIELD OF THE TECHNOLOGY

The present technology relates generally to secure messaging, and more particularly, but not by limitation, to systems and methods for secure messaging that allow modular subsystem isolation, as well as latency remediation and improved user experiences.

### SUMMARY

Exemplary embodiments include a secure messaging system configured with at least one processor to execute instructions stored in memory, the system comprising a data retention system and a data science system, a web services layer providing access to the data retention and data science systems, a batching service, wherein an application server layer transmits a request to the web services layer for data, the request processed by the batching service transparently to a user, the request processed by the batching service transparently to the user such that the user can continue to use a user-facing application without disruption, an application server layer that provides the user-facing application that accesses the data retention and data science systems through the web services layer, and performs processing based on user interaction with a messaging application, the messaging application configured to execute instructions including generating a dynamically displayed specific, structured interactive graphical user interface paired with a prescribed functionality directly related to the interactive graphical user interface's structure.

According to further exemplary embodiments, the data retention system and the data science system are both in secure isolation from a remainder of the secure messaging system, the user-facing application being secured through use of a security token cached on a web browser that provides the user-facing application, and the application server layer performs asynchronous processing.

The prescribed functionality, in many exemplary embodiments, is for a new issuance, including size and maturity, a new issuance, including pricing strategy, a new issuance, including benchmark spotting, a new issuance, including scheduling of a pricing auction, an issuance, including a starting bid date and time, an issuance, including an in pricing screen, a tranche summary, including volume distribution and award distribution, a tranche summary, including individual bids, a tranche summary, including allocation and concentration settings, an issuance, including initial round completion data, an issuance, including final round status, an issuance, including final round completion data, an issuance, including benchmark spotting selection settings, an issuance, including benchmark spotting completion data, and/or a tranche summary, including volume distribution and award distribution after benchmark spotting completion.

Even further exemplary embodiments include a dynamic feedback loop back into the system for making automatic adjustments based on actual performance versus predicted performance to automatically make the system more accurate.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of a computing architecture that includes a system constructed in accordance with the present disclosure.

FIG. 2 is an exemplary dynamically displayed specific, structured interactive graphical user interface paired with a prescribed functionality directly related to the interactive graphical user interface's structure. Here, the prescribed functionality is for a new issuance.

FIG. 3 is an exemplary dynamically displayed specific, structured interactive graphical user interface paired with a prescribed functionality directly related to the interactive graphical user interface's structure. Here, the prescribed functionality is for a new issuance.

FIG. 4 is an exemplary dynamically displayed specific, structured interactive graphical user interface paired with a prescribed functionality directly related to the interactive graphical user interface's structure. Here, the prescribed functionality is for a new issuance.

FIG. 5 is an exemplary dynamically displayed specific, structured interactive graphical user interface paired with a prescribed functionality directly related to the interactive graphical user interface's structure. Here, the prescribed functionality is for an issuance.

FIG. 6 is an exemplary dynamically displayed specific, structured interactive graphical user interface paired with a prescribed functionality directly related to the interactive graphical user interface's structure. Here, the prescribed functionality is for an issuance.

FIG. 7 is an exemplary dynamically displayed specific, structured interactive graphical user interface paired with a prescribed functionality directly related to the interactive graphical user interface's structure. Here, the prescribed functionality is for an issuance.

FIG. 8 is an exemplary dynamically displayed specific, structured interactive graphical user interface paired with a prescribed functionality directly related to the interactive graphical user interface's structure. Here, the prescribed functionality is for a tranche summary.

FIG. 9 is an exemplary dynamically displayed specific, structured interactive graphical user interface paired with a prescribed functionality directly related to the interactive graphical user interface's structure. Here, the prescribed functionality is for a tranche summary.

FIG. 10 is an exemplary dynamically displayed specific, structured interactive graphical user interface paired with a prescribed functionality directly related to the interactive graphical user interface's structure. Here, the prescribed functionality is for a tranche summary.

FIG. 11 is an exemplary dynamically displayed specific, structured interactive graphical user interface paired with a prescribed functionality directly related to the interactive graphical user interface's structure. Here, the prescribed functionality is for an issuance.

FIG. 12 is an exemplary dynamically displayed specific, structured interactive graphical user interface paired with a prescribed functionality directly related to the interactive graphical user interface's structure. Here, the prescribed functionality is for an issuance.

FIG. 13 is an exemplary dynamically displayed specific, structured interactive graphical user interface paired with a prescribed functionality directly related to the interactive graphical user interface's structure. Here, the prescribed functionality is for an issuance.

FIG. 14 is an exemplary dynamically displayed specific, structured interactive graphical user interface paired with a prescribed functionality directly related to the interactive graphical user interface's structure. Here, the prescribed functionality is for an issuance.

FIG. 15 is an exemplary dynamically displayed specific, structured interactive graphical user interface paired with a prescribed functionality directly related to the interactive graphical user interface's structure. Here, the prescribed functionality is for an issuance.

FIG. 16 is an exemplary dynamically displayed specific, structured interactive graphical user interface paired with a prescribed functionality directly related to the interactive graphical user interface's structure. Here, the prescribed functionality is for a tranche summary.

### DETAILED DESCRIPTION

Generally speaking, the present disclosure provides a secure messaging system configured by at least one processor to execute instructions stored in memory, the system comprising a data retention system and a data science system, a web services layer providing access to the data retention and data science systems and an application server layer that provides a user-facing application for issuing debt instruments and a dynamic feedback loop back into the system for making automatic adjustments based on actual performance to automatically make the system more intelligent.

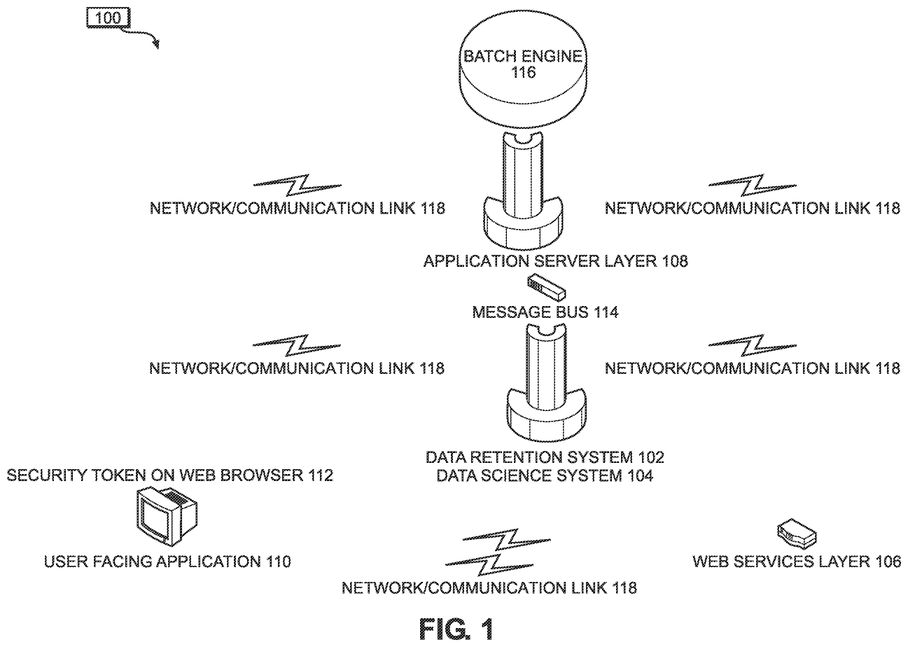

FIG. 1 is a schematic diagram of an example secure messaging system (hereinafter system 100) for practicing aspects of the present disclosure. The system 100 comprises a data retention system 102, a data science system 104, a web services layer 106, and an application server layer 108 that provides, for example, modeling. Some or all of the activities occur over one or more network/communication links 118.

In some embodiments, the data retention system 102 and data science system 104 are in secure isolation from a remainder of the secure messaging system 100 through a security protocol or layer. Data science is an interdisciplinary field that uses scientific methods, processes, algorithms and systems to extract knowledge and insights from noisy, structured and unstructured data, and apply knowledge and actionable insights from data across a broad range of application domains. Data science is related to data mining, machine learning and big data. The data retention system 102 can also provide additional services such as logic, data analysis, risk model analysis, security, data privacy controls, data access controls, disaster recovery for data and web services—just to name a few.

The web services layer 106 generally provides access to the data retention system 102. According to some embodiments, the application server layer 108 is configured to provide a user-facing application 110 that accesses the data retention 102 and data science 104 systems through the web services layer 106. In some embodiments, the user-facing application 110 is secured through use of a security token cached on a web browser 112 that provides the user-facing application 110.

In one or more embodiments, the application server layer 108 performs asynchronous processing based on user interaction with a messaging application (referred to herein as a user-facing application/interface) that processes data from a user. A messaging application can reside and execute on the application server layer 108. In other embodiments, the messaging application may reside with the data science system 104. In another embodiment, the messaging application can be a client-side, downloadable application.

The systems of the present disclosure implement security features that involve the use of multiple security tokens to provide security in the system 100. Security tokens are used between the web services layer 106 and application server layer 108. In some embodiments, security features are not continuous to the web browser 112. Thus, a second security layer or link is established between the web browser 112 and application server layer, 108. In one or more embodiments, a first security token is cached in the application server layer 108 between the web browser 112 and the application server layer 108.

In some embodiments, the system 100 implements an architected message bus 114. In an example usage, a user requests a refresh of their data and user interface through their web browser 112. Rather than performing the refresh, which could involve data intensive and/or compute or operational intensive procedures by the system 100, the message bus 114 allows the request for refresh to be processed asynchronously by a batching process and provides a means for allowing the web browser 112 to continue to display a user-facing application to the user, allowing the user to continue to access data without waiting on the system 100 to complete its refresh.

Also, latency can be remediated at the user-facing application based on the manner with which the user-facing application is created and how the data that is displayed through the user-facing application is stored and updated. For example, data displayed on the user-facing application that changes frequently can cause frequent and unwanted refreshing of the entire user-facing application and GUIs. The present disclosure provides a solution to this issue by separating what is displayed on the GUI with the actual underlying data. The underlying data displayed on the GUI of the user-facing application 110 can be updated, as needed, on a segment-by-segment basis (could be defined as a zone of pixels on the display) at a granular level, rather than updating the entire GUI. That is, the GUI that renders the underlying data is programmatically separate from the underlying data cached by the client (e.g., device rendering the GUIs of the user-facing application). Due to this separation, when data being displayed on the GUI changes, re-rendering of the data is performed at a granular level, rather than at the page level. This process represents another example solution that remedies latency and improves user experiences with the user-facing application.

To facilitate these features, the web browser 112 will listen on the message bus 114 for an acknowledgement or other confirmation that the background processes to update the user account and/or the user-facing application have been completed by the application server layer 108. The user-facing application (or even part thereof) is updated as the system 100 completes its processing. This allows the user-facing application 110 provided through the web browser 112 to be usable, but heavy lifting is being done transparently to the user by the application server layer 108. In sum, these features prevent or reduce latency issues even when an application provided through the web browser 112 is “busy.” For example, a re-balance request is executed transparently by the application server layer 108 and batch engine 116. This type of transparent computing behavior by the system 100 allows for asynchronous operation (initiated from the application server layer 108 or message bus 114).

In some embodiments, a batch engine 116 is included in the system 100 and works in the background to process re-balance requests and coordinate a number of services. An example re-balance request would include an instance where a user selectively changes a goal. The batch engine 116 will transparently orchestrate the necessary operations required by the application sever layer 108 in order to obtain data.

According to some embodiments, the batch engine 116 is configured to process requests transparently to a user so that the user can continue to use the user-facing application 110 without disruption. For example, this transparent processing can occur when the application server layer 108 transmits a request to the web services layer 106 for data, and a time required for updating or retrieving the data meets or exceeds a threshold. For example, the threshold might specify that if the request will take more than five seconds to complete, then the batch engine 116 can process the request transparently. The selected threshold can be system configured.

In some embodiments, security of data transmission through the system 100 is improved by use of multiple security tokens. In one embodiment a security token cached on the web browser 112 is different from a security protocol or security token utilized between the application server layer 108 and the web services layer 106.

The user-facing application, according to exemplary embodiments, shall perform the following (among other things):

Pre-Deal

Reverse Inquiry from Investors to Issuers

Investors are able to indicate what debt they are interested in buying. This will include maturities, industry sectors, credit ratings, specific company names, amounts and price ranges. The platform will aggregate this information and present it to Issuers on the platform whose profile fits the different interests. With performance history on the platform, a scoring system will be added to indicate those Investors who are more serious in their interests and likely to follow through if a deal is brought meeting their needs as entered through reverse inquiry.

Testing the Waters

Direct interaction between the Issuers of debt and their Investors is enabled to determine likely demand for a planned issue.

Issuer can customize who they want to send the request to.

The platform will learn through historical participation deals and additional information on an issuers' off-platform issues which investors are the best indicators of where an actual deal will come out, enabling Issuers to fine tune their messaging.

Issuers will be able to get preference for floating or fixed coupons

In addition to polling investors the platform will (over time) provide analytics on similar recent deals on the platform based on both the issuer profile and the deal characteristics. These analytics will be combined with market analytics on secondary trading to give the Issuer information to support their decision on what to go to market with.

To further help Issuers make deal design decisions will show the impact of particular deal features on final pricing across the platform. This will allow them to go into the model, create a deal and get a model predicted outcome.

Investor Set-Up

As part of the investor onboarding process the application will be used to determine initial limits for investors bidding on auctions. Performance in terms of honoring orders and settling in an orderly manner will be monitored and contribute to reputation score on the platform. Conversely, failed trades or difficult settlement will reduce the reputation score and lead to red flags whereby an investor has their limits reduced or potentially barred from the system. Any credit limits or “red-flags” will be applied dynamically during the auction.

The Auction

Documentation

Deal documentation including preliminary and final prospectus, bond indenture that are filed with the SEC will be made available on the platform (via links) and stored so that they can easily be accessed by the Issuer. A feature will be developed to allow for the creation of deal documents from templates driven by platform inputs. The final documents will still be the responsibility of the Issuer but this will speed up documentation which will be important particularly in MTN programs where the deal size could be quite small. Investors once notified of the deal will be able to see all relevant documents in one place. Investors can opt to be notified of every deal on the platform or can set criteria based on their investment objectives.

Deal Setup

Issue Date

Issuer enters a date for the issue[s] to be priced

Currency

Currently system defaults to USD.

Maturity

The Issuer selects one or more maturity tranches for the notes offered in the deal. The Issuer also is able to set custom maturities that may not be in the default set.

Aggregate Principal Amount Offered Across All Tranches

The aggregate principal amount across all tranches that will not be exceeded.

This aggregate principal amount may or may not be displayed to potential buyers.

Items Set for Each Tranche

| Item | Description | Display to Buyers |
|---|---|---|
| Type | Fixed or Floating Rate | YES |
| Target principal | The Issuer's desired issue | NO |
| amount | size | |
| Min principal | The minimum principal | YES |
| amount | amount that the Issuer will | |
| | offer. If cancel feature is | |
| | turned on, if the Issuer | |
| | does not receive | |
| | indications for at least this | |
| | amount in bids at or above | |
| | the reserve price, the | |
| | tranche can be cancelled, | |
| | in the Issuer's sole | |
| | discretion | |
| Max principal | The maximum principal | Optional but |
| amount | amount for each tranche | generally |
| | that the Issuer is prepared | would be displayed |
| | to offer, which cannot | |
| | exceed the overall | |
| | aggregate | |
| Target price | Issuer's desired price | NO |
| | levels | |
| Reserve price | Price to qualify for the | NO |
| | final round of the auction. | |
| | Also used in tranche | |
| | cancellation rules and | |
| | drives some other | |
| | calculations | |
| Benchmark | The reference Treasury | YES |
| | maturity or floating | |
| | coupon reference (e.g. 3- | |
| | month LIBOR) | |

In some exemplary embodiments of the system, the Reserve Price is not displayed to auction participants. If this is allowed to be displayed by the Issuer, the application would change the bidding rules during the first round. Bids outside of the reserve price would not be accepted. This would also open up the possibility of allowing the Issuer to relax the reserve price at the end of the first round if the Min Principal Amount were not reached instead of just cancelling that tranche. This would require a new “initial round” where everyone would have the chance to bid again.

### Supporting Analytics

The application, according to various exemplary embodiments, will provide the Issuer with market data and calculations showing the Issuer where their secondary issues are trading and comparable recent primary issues. These may involve yield curve calculations and comparisons to different benchmarks. These will not be recommendations, but an Issuer could use the information to supplement their own calculations and research (in-house or provided from external sources).

Number and Duration of Rounds

Currently, the only choice is a two-round structure: Initial and Final

Initial Round

Duration and End Trigger

Determines when the initial round will end at the earlier of Duration in minutes (likely 60-90 minutes) or the End Trigger which is set off a multiple of times coverage of the Max Principal Amount per tranche.

Final Round

Duration

Time in minutes (likely in the 15-30 min range)

Interval Between Rounds

Time in minutes

Spotting Treasuries (Determining Fixed Coupons)

This feature is used to allow live setting of the Treasury reference rates. The issuer can fix the coupons at any time during this window

Final Allocation is the end of the Final Round of bidding.

Issuer specifies the window by setting when Spotting Starts after Final Allocation and the window Duration in minutes. The Benchmark Provider will be the pricing source for the Treasuries. Most likely Bloomberg or Refinitiv.

Additional Setup Features by Tranche

| Item | Description | Display to Buyers |
|---|---|---|
| Allow Hedge | Currently only one | YES |
| Funds or | selection is available: | |
| other categories? | Hedge Funds. Buyers will be | |
| | classified by type and this | |
| | will prevent those flagged | |
| | as Hedge Funds from | |
| | participating in the auction | |
| | unless the box is checked. | |
| | This is an example of a | |
| | more general feature to | |
| | manage investor | |
| | diversification that would | |
| | allow the Issuer to limit the | |
| | percentage allocation to a | |
| | category of investors, | |
| | rather than simply exclude | |
| | them outright. | |
| Allow Issuer | Is checked, then if min | YES |
| to Cancel Tranche | principal amount of bids at | |
| | or better than reserve price | |
| | is not received by end of | |
| | first round, the Issuer can | |
| | cancel tranche | |
| Min Award Rules | The minimum allocation | YES |
| | and minimum increment | |
| | of allocation. Affects | |
| | rounding in allocation | |
| Preference | A portion of the deal tranche | YES |
| Allocation | used to reward investors | |
| | who bid aggressively | |
| | early (see below) | |
| Concentration | Single bidder or group of | YES |
| Limits | bidder limits that will | |
| | potentially reduce allocations. | |
| | Applied on a live basis | |
| | so bidder will see their effect | |
| Principal Amount | How deal tranche size can | YES, but not |
| Increase rules | be increased or shifted | precise rules |
| | between tranches (see below) | |

Additional Setup Features by Tranche

Preference Allocation

This is a proprietary feature of the model. It applies during a time window that ends at the earlier of a set duration in minutes or when a multiple of target volume is hit. The Issuer reserves a percentage of the deal tranche that can be awarded to bidders who place bids during the preference window. The total amount of awards can be less than the maximum percentage. It depends on the amount of bids and their level. Bids closer to the target price will get a bigger award than those near the reserve. All bids are treated equally with respect to time provided they are made during the window: there is no time stamp preference. Awards will also be modified by other applicable rules such as concentration limits.

The percentage reserved for the Preference Allocation is a maximum. It is quite likely that the awarded amount of preference awards will be less than this. Bidders will be notified of any Preference Award and have an opportunity to accept or reject it. The recipient of the award will be able to either accept the Preference Award in addition to their existing bid amount or convert some or all of their existing bid into a Preference Amount. The Preference Award will only take effect if the bidder is still in the winning group at the end of the Final Round of bidding.

Rewarding Loyalty

Issuers want to be able to reward the behavior of investors who contribute to the long-term success of their deals. The platform delivers this through an intelligent loyalty feature that looks at how each investor bids on every deal and then how the deal trades in the secondary market for a defined period after the deal has been priced.

Loyalty will be based on algorithm that starts with detailed inputs on bidding behavior and the resulting performance of the deal's credit spread relative to its benchmark in the secondary market. Success will be measured by looking at whether the deal fell in certain range. The model will improve over time by refining the inputs and learning across all deals on the platform what contributes to success.

Loyalty is rewarded through additional allocation or price preferences on bids. The Issuer will receive a recommendation from the platform during the set-up stage on what amount of loyalty award is predicted to optimize the long-term benefits to them. The issue can go with the recommendation or enter their own amount or not have any loyalty preference at all.

Preferred Investor Group Preference

The platform allows Issuers to carve out a portion of the deal amount to be given as a preference to a particular group. For example, minority, women, or veteran owned investors. The platform will dynamically adjust the allocation at the clearing price to give these groups an amount up to the carve out before other rules apply. This feature ranks after the Preference Allocation described above. After the carve out has been fully allocated, remaining bids by this group of investors will be allocated proportionally as they are for other investors. In the future this feature will be enhanced to allow for this group of investors to get an additional advantage whereby their bids are treated advantageously with regard to price. This could result in the clearing price being wider in terms of spread (worse for the issuer) and so dynamic budgeting to allow the cost of the feature to be limited by the Issuer.

Principal Amount Increase Rules

These rules govern how the principal amount of a tranche can be increased from the target amount to the maximum amount for each tranche. Increases are driven by a clearing bid level that is better than the target price. The rules do not allow for the total principal amount across the tranches to exceed the Aggregate Maximum Principal Amount.

The rules will also allow for the amounts to be shifted between tranches on the basis of the relative strength of bids compared to the target price for each tranche. Bidders will know that principal amount can vary between above the displayed Min and Max Principal Amounts (the latter only if displayed) by tranche and that the Aggregate Maximum Principal Amount cannot be exceeded. Volume adjustments are dynamic during the auction and bidder allocations will be adjusted live.

Conducting the Auction

Go No Go Decision

Once the Issuer has decided to proceed, the deal launch will be announced publicly on the platform but also through other media such as Bloomberg. The Issuer will file the preliminary pricing supplement or preliminary prospectus supplement with the SEC and these will also be posted on the platform. The start time and rules for the auction will be displayed and the general auction terms will be described in the preliminary pricing supplement or preliminary prospectus supplement.

Eligibility

To be eligible to bid in the auction bidders will already have to be signed up on the platform. Depending on Issuer set preferences they may not be eligible to participate in an auction for a specific deal.

Filtering Bidders

It is expected that the initial set of bidders will be very familiar to the earlier issuers and so almost all of them will be acceptable but there might be individual names with which they have a bad history. Over time, the application will be able to build a history for each bidder and exclude someone if they have a history of failing on trades.

First/Initial Round

Bidders enter one bid volume and price. This bid is firm. If they bid during the preference window and have won a Preference Allocation, they will be notified of this and will be given an opportunity to accept or reject it before the start of the Final Round.

To qualify for the Final Round bidders must bid at or better than the reserve price. Those bidders who are currently not qualified will be warned that they will be eliminated and given one opportunity to improve their bid. They have to submit any revised bid by the end of the First Round. During the bidding, the Issuer will see the details of all bids and current allocations. Buyers will see their own allocations. A graph or the total volume bid for each tranche plus summary statistics on price will be displayed to all buyers. The display will “turn on” when any one of several triggers related to coverage of the deal target amount has been hit, or a time limit related to the end of the end of the first round is reached, whichever happens earlier. The rules for this will be preset in the system.

End of First Round Cancelling Tranches

At the end of the first round, if the deal tranche is cancelable and the bids at or better than the reserve price or the tranche total less than the minimum principal amount for the tranche, then the Issuer will cancel the tranche and notify all participants

Final Round

Bidders are allowed to set multiple bids for the final round. The bidder can choose the number of distinct levels to submit prior to the start of the Final Round. All bids are firm on price and principal amount. Any price entered is considered to be the maximum that the bidder will pay for the desired principal amount.

| Item | Description |
|---|---|
| Allow multiple bids | These allow a bidder to specify lower amounts for |
| with different price | more aggressive price bids. |
| and principal amount | For example, $100 million @ 100 BP spread but |
| combinations | only $70 million if the spread goes to 70 BP. |
| | Only the most aggressive price level can be |
| | improved and this only by improving the |
| | bid—see below |
| Number of price/ | There will be a system limit |
| amount levels | |
| allowed with | |
| multiple bids | |
| Manual Adjustment | In addition to submitting bids prior to the start of |
| of “best level” | the Final Round the Bidder can actively change |
| | their best bid level. They can only either: |
| | Increase principal amount and improve the price |
| | OR improve the price without changing the |
| | principal amount |
| Bidding without | There is no requirement to use the multiple level |
| multiple levels | functionality. A bidder could just enter a single bid |
| | price and amount. |
| | They would then be able to improve this |
| | manually but can only either: |
| | Increase principal amount and improve the price |
| | OR improve the price without changing the |
| | principal amount. |
| | They cannot reduce principal amount nor increase |
| | principal amount without a simultaneous |
| | improvement in price |

How Bids Will be Changed by the Application

Starting from the bids at the end of the Initial Round, a bid will only be incremented if the current allocation is below the bid amount for each bidder. If the bidder currently has no allocation, they will first be moved up to the first price level that will give them at least a partial allocation. Otherwise, the minimum increment for bids is 1 BP or spread (0.01%). For example, Bidder A bid 100 BP for $100 million in the First Round. For the Final Round they submitted a bid of 90 BP (they did not use the multi bid functionality so the volume is not changed). Their bid will be kept at 100 BP unless they need to increase it to get $100 million. This will happen if there are sufficient bids ahead of them for the adjusted target volume. This will be the normal situation at the start of the Final Round when the Initial Round has been oversubscribed. Principal amount increases to individual tranches will only take place if the target amount for the issuer is met. The principal amount will not be reduced below this level by increasing bids that might reduce the total amount demanded.

Multi-Level Price/Principal Amount Bids

The first level applies up to and including the price for that level. The next band applies if the price is improved beyond that point. Again, the bids are never improved if tranche amount would fall below the target and all bids are firm.

### Example

| Price/Principal | | Principal |
|---|---|---|
| Amount Bid | Applies when Spread | Amount Bid |
| 100 BP/$100 million | Greater than or equal | $100 million |
| | to 100 BP | |
| 90 BP/$70 million | Less than 100 BP | $70 million |
| | greater than or equal | |
| | to 90 BP | |
| 85 BP/$40 million | Less than 90 BP greater | $40 million |
| | than or equal to 85 BP | |
| | Less than 85 BP | Zero |

Allocations to Bidders at the Current Clearing Price

All allocations are awarded at a single Clearing Price. This is the level at which the Target Principal Amount plus or minus any volume adjustments can be sold. The total amount of bids awarded will be the between the Minimum and Maximum Principal Amount for the tranche as determined by the principal amount adjustment rules. Bids at better levels than the clearing price will be awarded in full. If the amount of bids at the Clearing price exceeds the remaining available amount offered, then bidders at the clearing price with a Preference Award will be allocated first, then bidders within a group as described herein, any remaining amount will be allocated pro rata taking into account the minimum allocation amount and the minimum increment of allocation. This will be calculated live and does not wait until the end of auction.

Ending the Auction

When there are no further changes to be made to bids the clearing price and allocations are set for each tranche. The Final Round will continue until the set time limit to allow for any manual bid changes.

Spotting the Treasuries for Fixed Coupons

The window for spotting (fixing) the Treasury benchmarks and determine the coupons of the fixed tranches will open as described in the setup. Live benchmark rates for each tranche together with calculated coupon rates will be shown as soon as the window opens. The Issuer has the option to round the coupon (to the nearest 0.125% or 0.05%, for example) and the display will show the final price together with gross proceeds. The Issuer and buyers can arrange to be ready to unwind any hedges they might have. The Issuer might also be using this window to swap a fixed issue into floating. The Issuer can fix the rates at any time within the prescribed window. If the Issuer determines that the market conditions are too volatile, they may postpone the window until no later than TBD by notifying all participants.

Transmission of Allocations and Finalization of Deal Docs

The electronic file of allocations is sent to the Issuer. The final term sheet is prepared, circulated to all parties for review and sign off, and, once approved, will be promptly filed with the SEC. The application will use the final term, which is the time of sale information, to confirm orders with the auction bidders. The issuer, its counsel, and the application will complete the final pricing supplement or final prospectus supplement, which must be filed with the SEC within 48 hours.

Possible Reallocation of Portion of Issue

Winning bidders will receive and electronic notification of their winning bid amount immediately after the close of the auction. If a buyer actively DKs the trade during a set window of time their allocation could be reoffered in the following way.

To bidders at the clearing price whose allocation was less than their volume bid.

Each bidder in this category would be asked how much extra volume they wanted up to the amount of their last bid.

The available bonds would be awarded on a prorate basis to the amounts requested, observing the minimum award increment.

To the best winning bidder, they would have right of refusal for the entire remaining reoffered amount at the clearing price.

To the second-best bid in the same way and so on until the full reoffered amount has been covered.

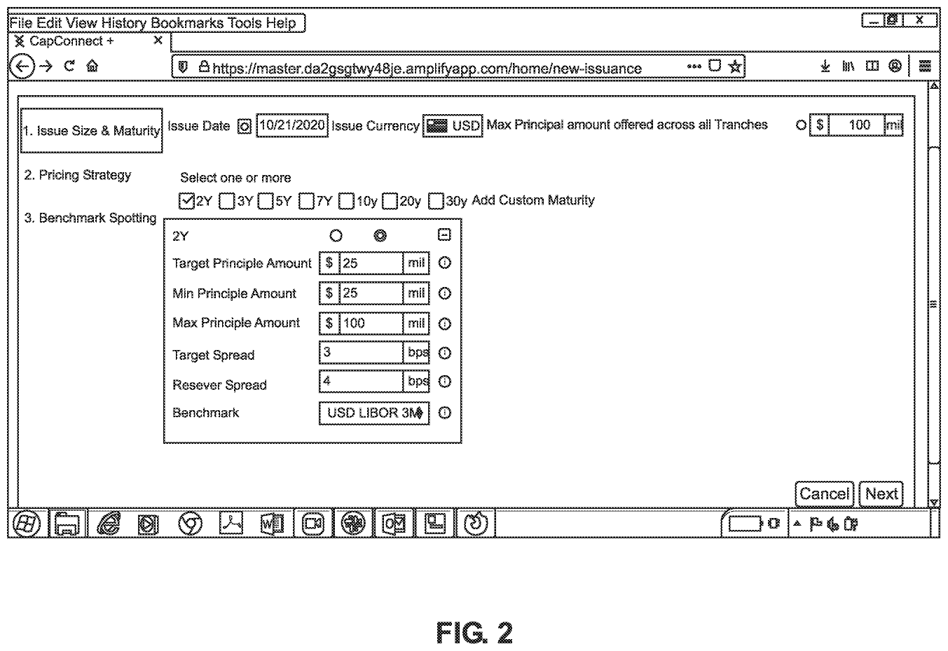

FIG. 2 is an exemplary dynamically displayed specific, structured interactive graphical user interface paired with a prescribed functionality directly related to the interactive graphical user interface's structure. Here, the prescribed functionality is for a new issuance, including issue size and maturity.

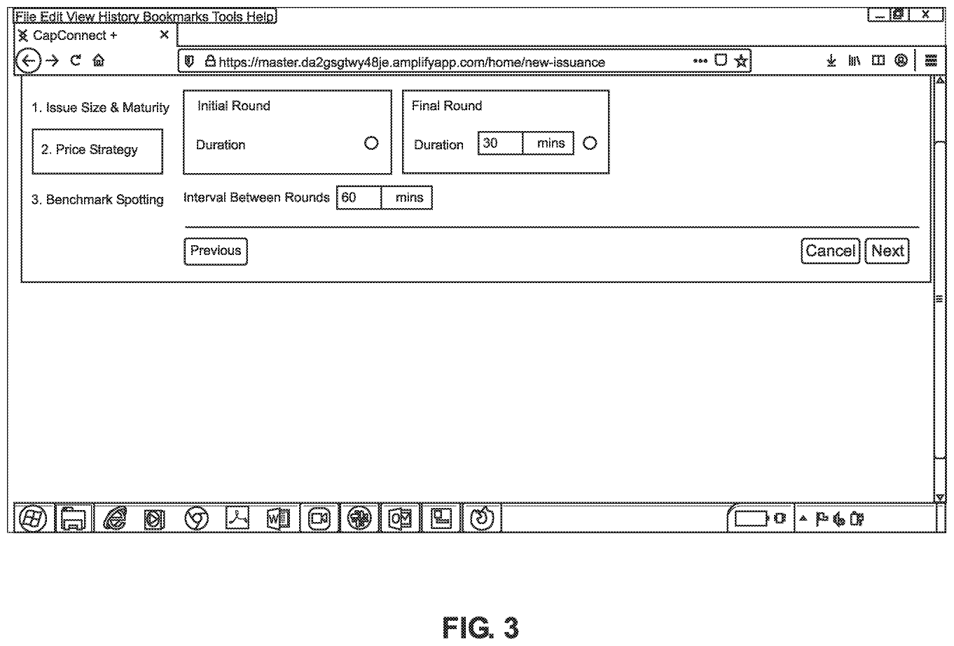

FIG. 3 is an exemplary dynamically displayed specific, structured interactive graphical user interface paired with a prescribed functionality directly related to the interactive graphical user interface's structure. Here, the prescribed functionality is for a new issuance, including pricing strategy.

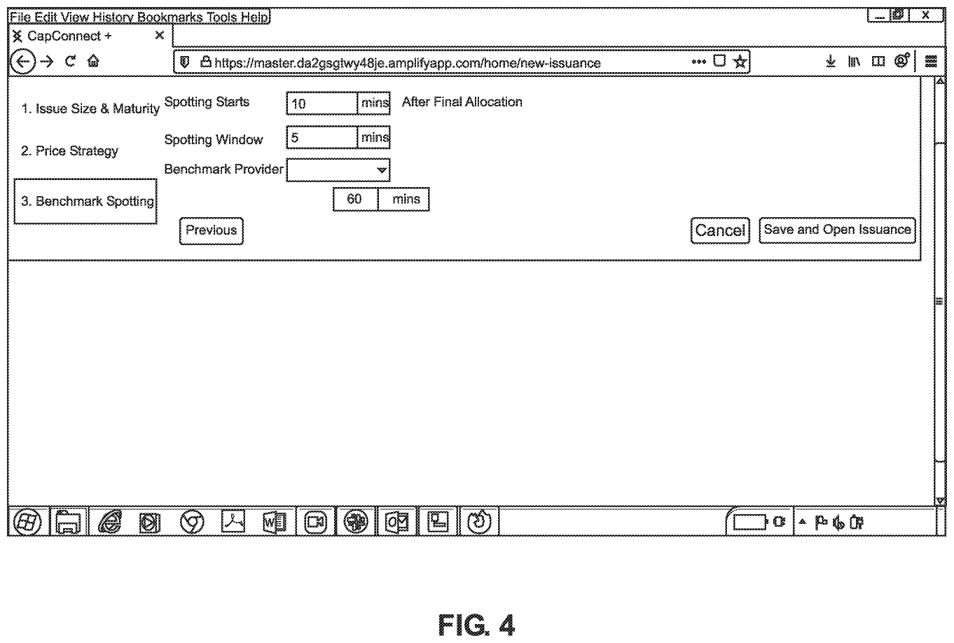

FIG. 4 is an exemplary dynamically displayed specific, structured interactive graphical user interface paired with a prescribed functionality directly related to the interactive graphical user interface's structure. Here, the prescribed functionality is for a new issuance, including benchmark spotting.

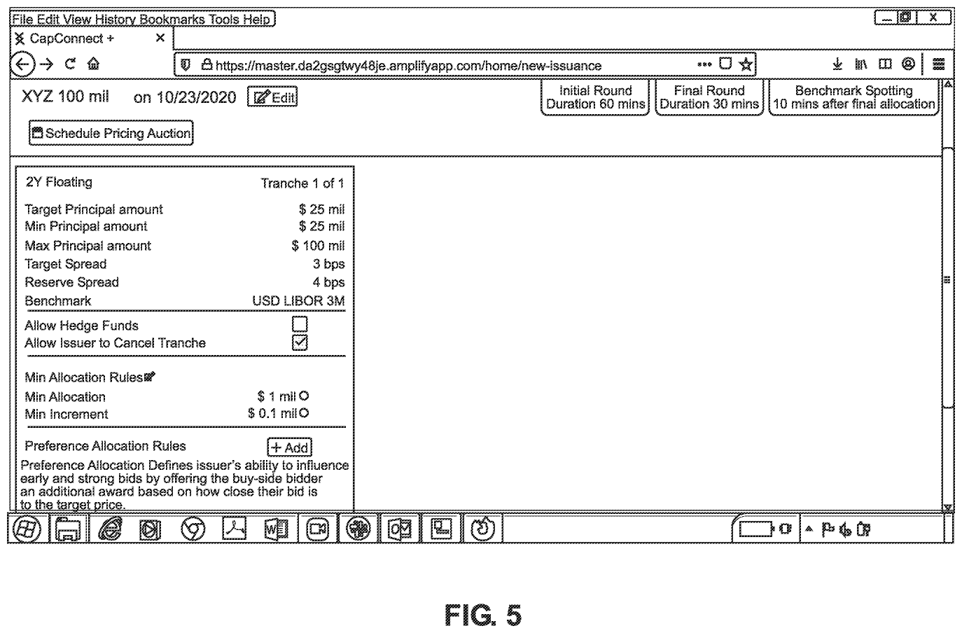

FIG. 5 is an exemplary dynamically displayed specific, structured interactive graphical user interface paired with a prescribed functionality directly related to the interactive graphical user interface's structure. Here, the prescribed functionality is for an issuance, including scheduling of a pricing auction.

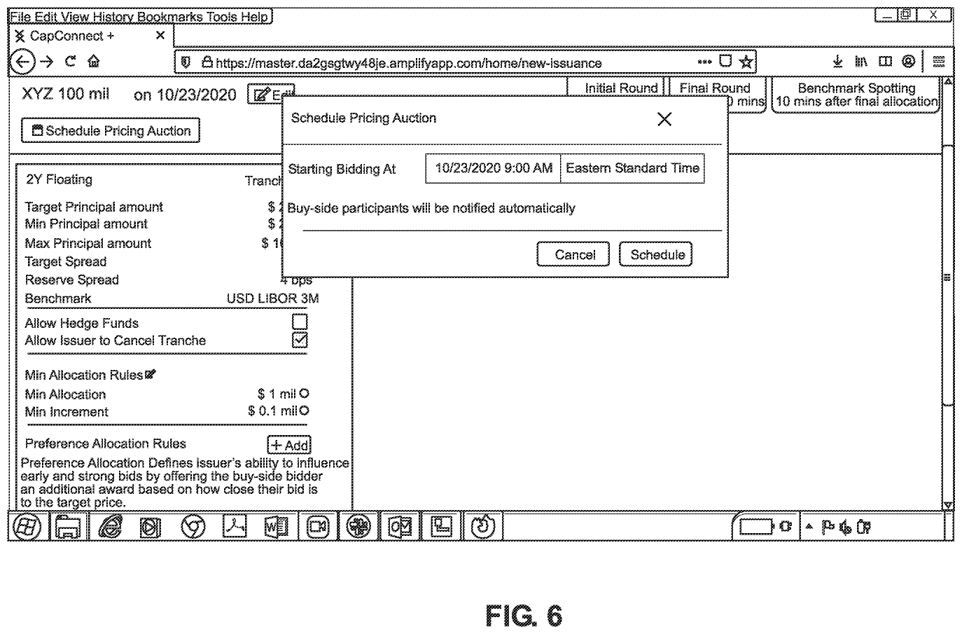

FIG. 6 is an exemplary dynamically displayed specific, structured interactive graphical user interface paired with a prescribed functionality directly related to the interactive graphical user interface's structure. Here, the prescribed functionality is for an issuance, including a starting bid date and time.

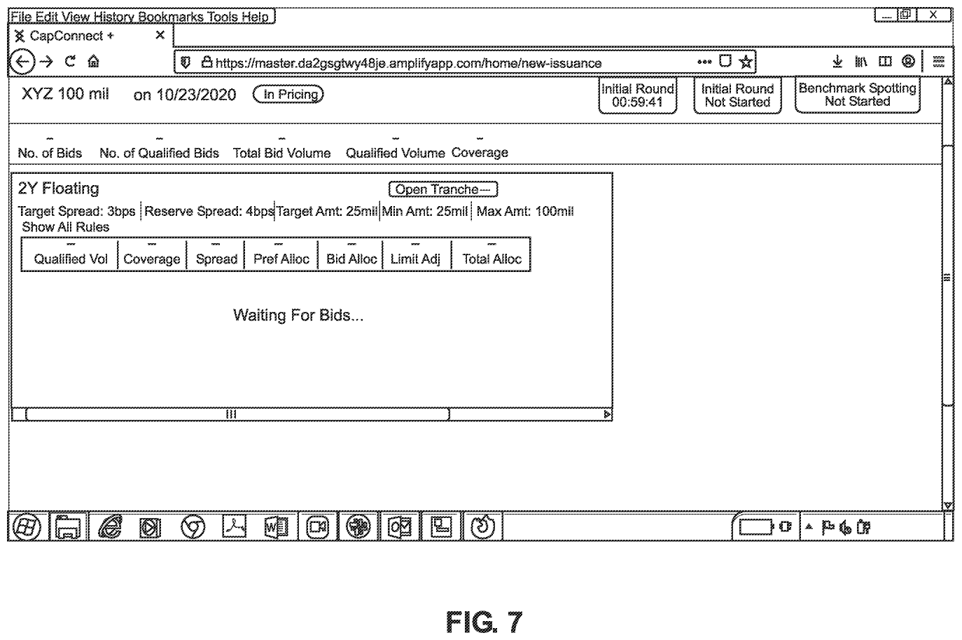

FIG. 7 is an exemplary dynamically displayed specific, structured interactive graphical user interface paired with a prescribed functionality directly related to the interactive graphical user interface's structure. Here, the prescribed functionality is for an issuance, including an in pricing screen.

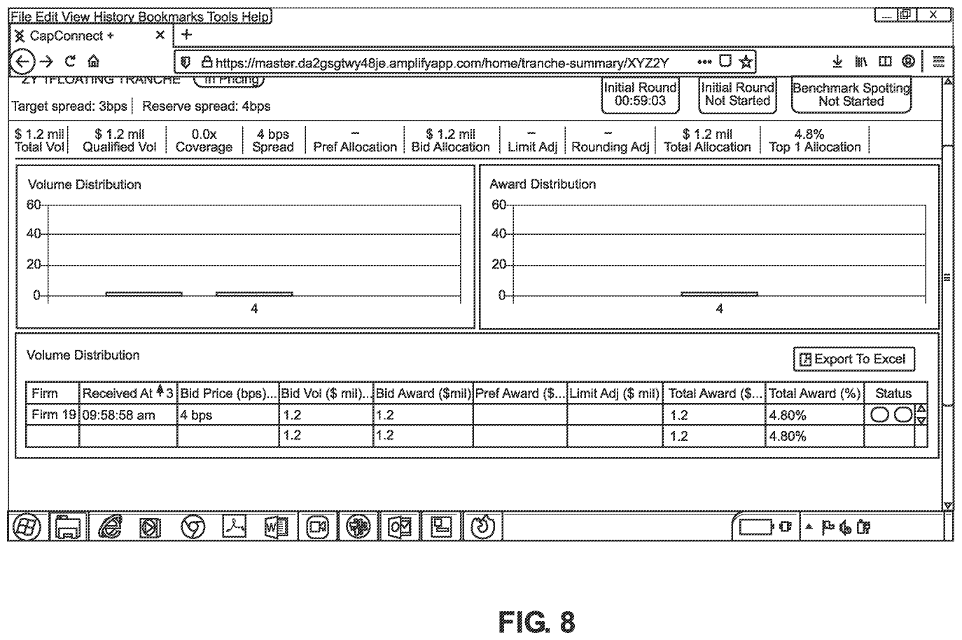

FIG. 8 is an exemplary dynamically displayed specific, structured interactive graphical user interface paired with a prescribed functionality directly related to the interactive graphical user interface's structure. Here, the prescribed functionality is for a tranche summary, including volume distribution and award distribution.

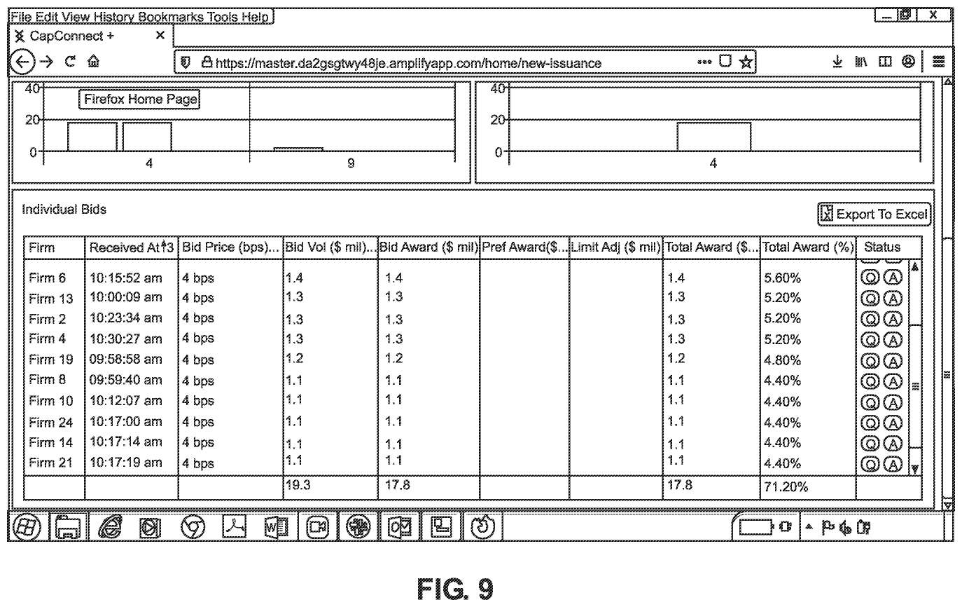

FIG. 9 is an exemplary dynamically displayed specific, structured interactive graphical user interface paired with a prescribed functionality directly related to the interactive graphical user interface's structure. Here, the prescribed functionality is for a tranche summary, including individual bids.

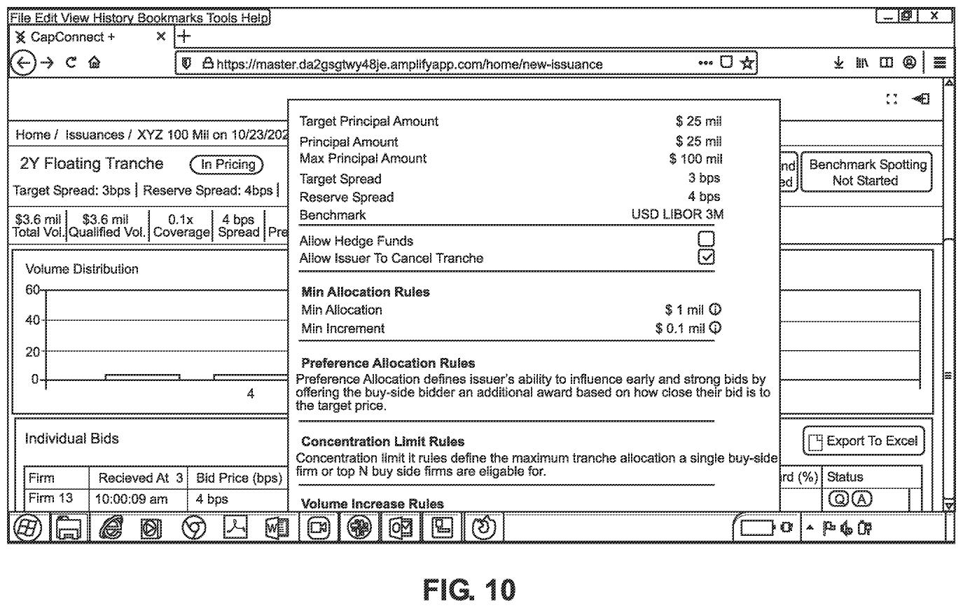

FIG. 10 is an exemplary dynamically displayed specific, structured interactive graphical user interface paired with a prescribed functionality directly related to the interactive graphical user interface's structure. Here, the prescribed functionality is for a tranche summary, including allocation and concentration settings.

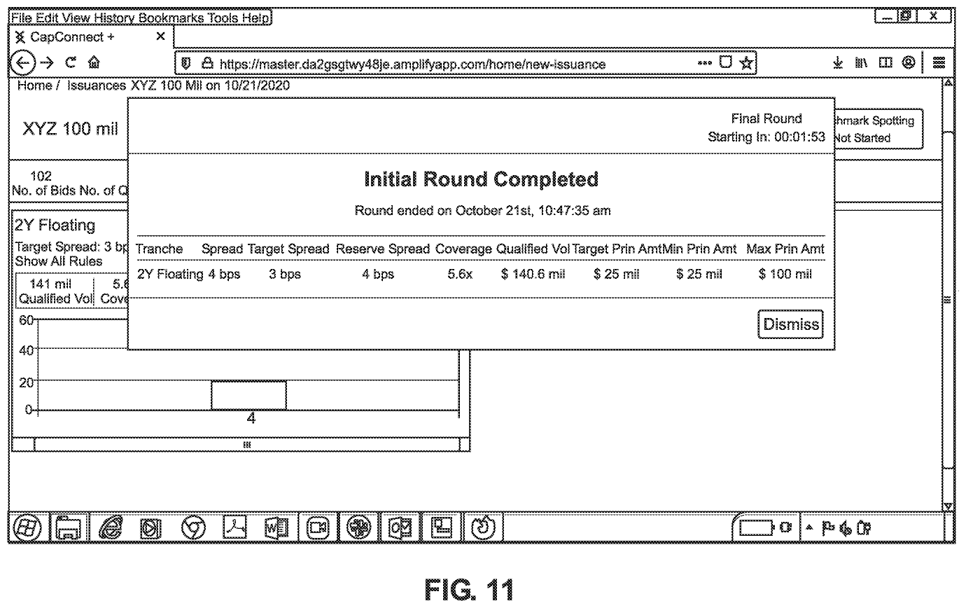

FIG. 11 is an exemplary dynamically displayed specific, structured interactive graphical user interface paired with a prescribed functionality directly related to the interactive graphical user interface's structure. Here, the prescribed functionality is for an issuance, including initial round completion data.

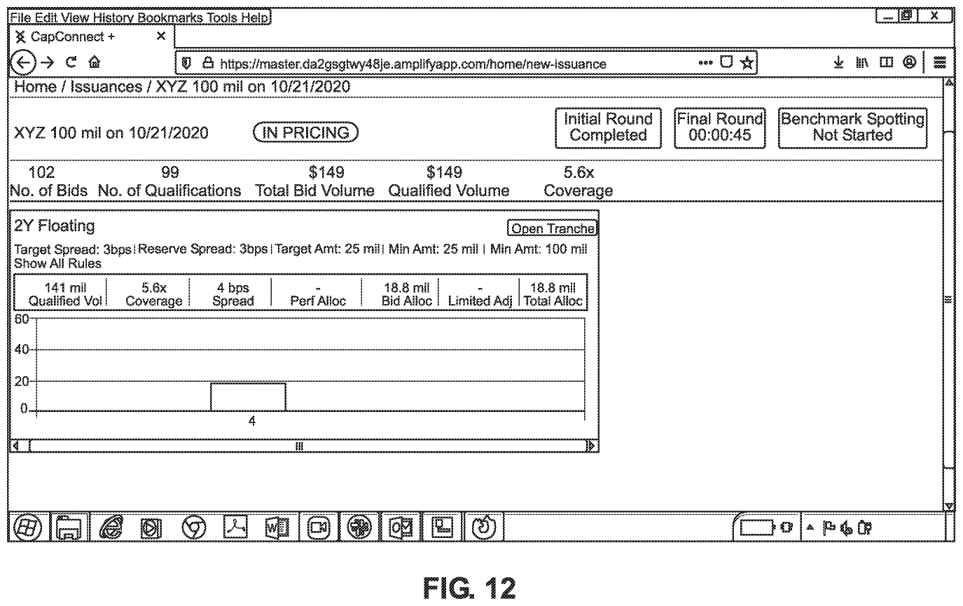

FIG. 12 is an exemplary dynamically displayed specific, structured interactive graphical user interface paired with a prescribed functionality directly related to the interactive graphical user interface's structure. Here, the prescribed functionality is for an issuance, including final round status.

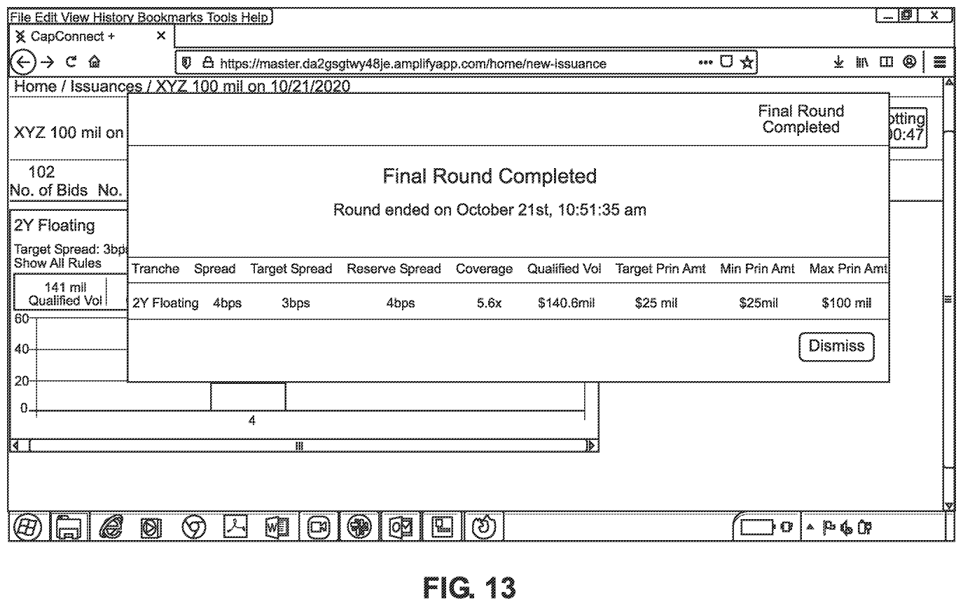

FIG. 13 is an exemplary dynamically displayed specific, structured interactive graphical user interface paired with a prescribed functionality directly related to the interactive graphical user interface's structure. Here, the prescribed functionality is for an issuance, including final round completion data.

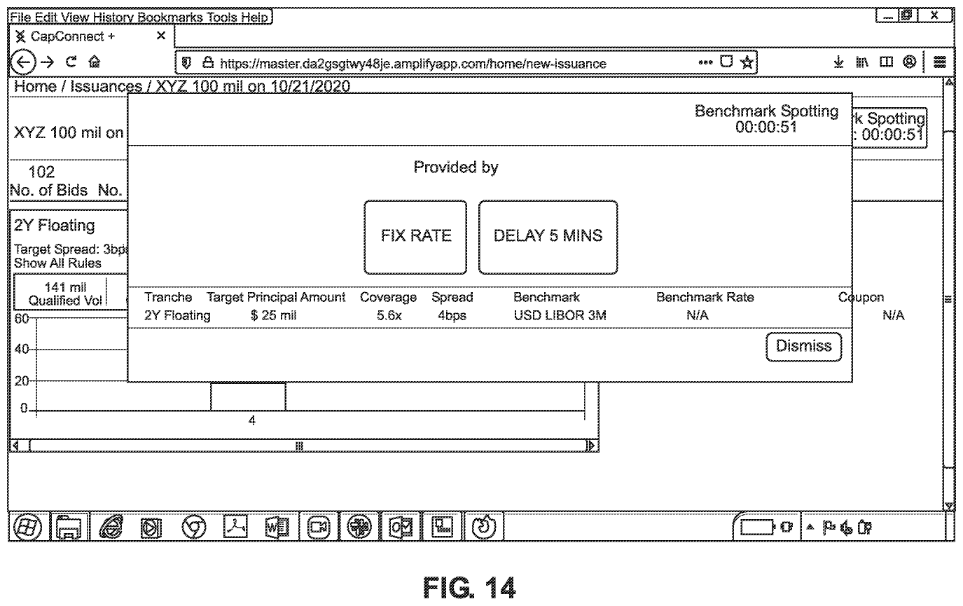

FIG. 14 is an exemplary dynamically displayed specific, structured interactive graphical user interface paired with a prescribed functionality directly related to the interactive graphical user interface's structure. Here, the prescribed functionality is for an issuance, including benchmark spotting selection settings.

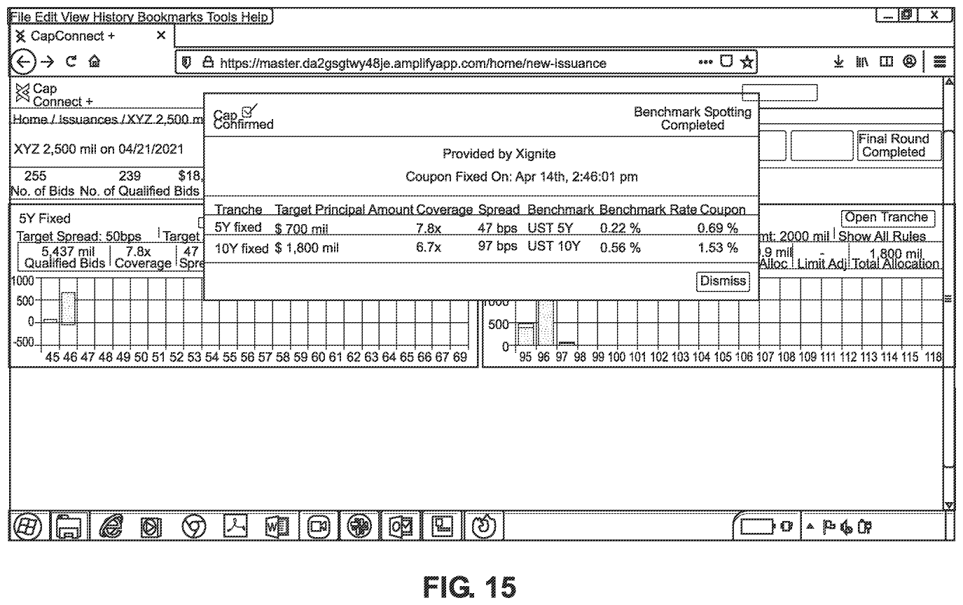

FIG. 15 is an exemplary dynamically displayed specific, structured interactive graphical user interface paired with a prescribed functionality directly related to the interactive graphical user interface's structure. Here, the prescribed functionality is for an issuance, including benchmark spotting completion data.

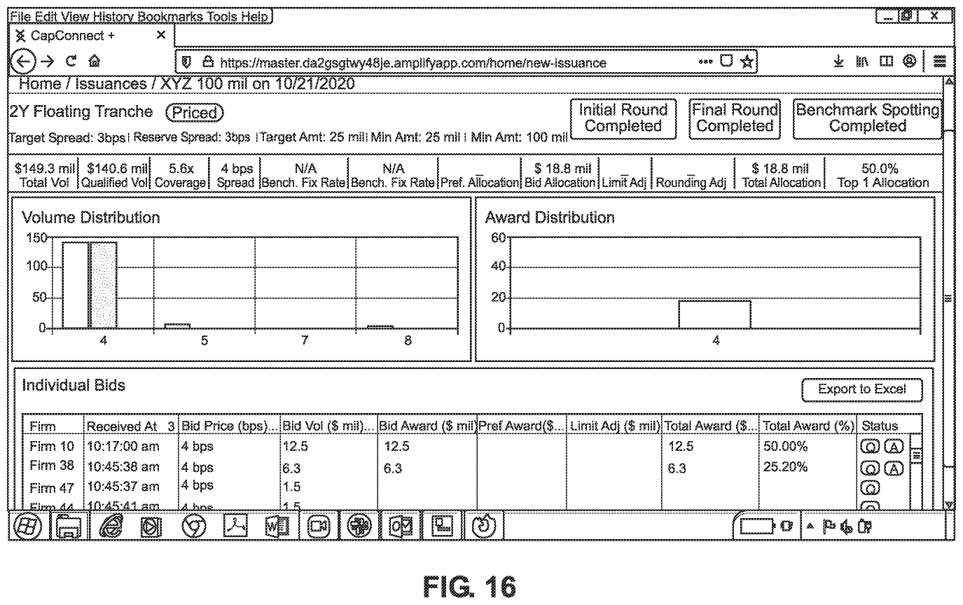

FIG. 16 is an exemplary dynamically displayed specific, structured interactive graphical user interface paired with a prescribed functionality directly related to the interactive graphical user interface's structure. Here, the prescribed functionality is for a tranche summary, including volume distribution and award distribution after benchmark spotting completion.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A secure messaging system configured by at least one processor to execute instructions stored in memory, the system comprising:
a data retention system and a data science system;
a web services layer providing access to the data retention and data science systems;
a batching service, wherein an application server layer transmits a request to the web services layer for data, the request processed by the batching service transparently to a user, the request processed by the batching service transparently to the user such that the user can continue to use a user-facing application without disruption;
an application server layer that:
provides the user-facing application that accesses the data retention and data science systems through the web services layer; and
performs processing based on user interaction with a messaging application, the messaging application configured to execute instructions including generating a dynamically displayed specific, structured interactive graphical user interface paired with a prescribed functionality directly related to the interactive graphical user interface's structure.

2. The secure messaging system of claim 1, further comprising the data retention system and the data science system are both in secure isolation from a remainder of the secure messaging system.

3. The secure messaging system of claim 1, further comprising the user-facing application being secured through use of a security token cached on a web browser that provides the user-facing application.

4. The secure messaging system of claim 1, further comprising the application server layer performing asynchronous processing.

5. The secure messaging system of claim 1, wherein the prescribed functionality is for a new issuance, including size and maturity.

6. The secure messaging system of claim 1, wherein the prescribed functionality is for a new issuance, including pricing strategy.

7. The secure messaging system of claim 1, wherein the prescribed functionality is for a new issuance, including benchmark spotting.

8. The secure messaging system of claim 1, wherein the prescribed functionality is for a new issuance, including scheduling of a pricing auction.

9. The secure messaging system of claim 1, wherein the prescribed functionality is for an issuance, including a starting bid date and time.

10. The secure messaging system of claim 1, wherein the prescribed functionality is for an issuance, including an in pricing screen.

11. The secure messaging system of claim 1, wherein the prescribed functionality is for a tranche summary, including volume distribution and award distribution.

12. The secure messaging system of claim 1, wherein the prescribed functionality is for a tranche summary, including individual bids.

13. The secure messaging system of claim 1, wherein the prescribed functionality is for a tranche summary, including allocation and concentration settings.

14. The secure messaging system of claim 1, wherein the prescribed functionality is for an issuance, including initial round completion data.

15. The secure messaging system of claim 1, wherein the prescribed functionality is for an issuance, including final round status.

16. The secure messaging system of claim 1, wherein the prescribed functionality is for an issuance, including final round completion data.

17. The secure messaging system of claim 1, wherein the prescribed functionality is for an issuance, including benchmark spotting selection settings.

18. The secure messaging system of claim 1, wherein the prescribed functionality is for an issuance, including benchmark spotting completion data.

19. The secure messaging system of claim 1, wherein the prescribed functionality is for a tranche summary, including volume distribution and award distribution after benchmark spotting completion.

20. The secure messaging system of claim 1, further comprising a dynamic feedback loop back into the system for making automatic adjustments based on actual performance versus predicted performance to automatically make the system more accurate.
